(19) United States
(12) Patent Application Publication
(10) Pub. No.: US 2015/0342837 A1
(43) Pub. Date: Dec. 3, 2015

(54) Vomit Collection Assembly

(71) Applicant: Laurent Leval, Oakville (CA)

(72) Inventor: Laurent Leval, Oakville (CA)

(21) Appl. No.: 14/292,173

(22) Filed: May 30, 2014

(51) Int. Cl. A61J 19/00; B65D 25/28

(52) U.S. Cl. CPC A61J 19/00; B65D 25/2829

(57) ABSTRACT

A vomit collection assembly for collecting vomit from an infant after the infant is burped includes a cup that collects vomit from the infant. A strap is coupled to the cup. The strap may insertably receive a user's hand. The cup is retained proximate the infant's mouth.

### BACKGROUND OF THE DISCLOSURE

### Field of the Disclosure

The disclosure relates to collection devices and more particularly pertains to a new collection device for collecting vomit from an infant when the infant vomits while being burped.

### SUMMARY OF THE DISCLOSURE

An embodiment of the disclosure meets the needs presented above by generally comprising a cup that collects vomit from an infant. A strap is coupled to the cup. The strap may insertably receive a user's hand. The cup is retained proximate the infant's mouth.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a vomit collection assembly according to an embodiment of the disclosure.

FIG. 2 is a front view of an embodiment of the disclosure.

FIG. 3 is a back view of an embodiment of the disclosure.

FIG. 4 is a top view of an embodiment of the disclosure.

FIG. 5 is a left side view of an embodiment of the disclosure.

FIG. 6 is an in-use view of an embodiment of the disclosure.

FIG. 7 is a perspective in-use view of an embodiment of the disclosure.

FIG. 8 is a schematic view of a method of utilizing an embodiment of the disclosure.

### DESCRIPTION OF THE PREFERRED EMBODIMENT

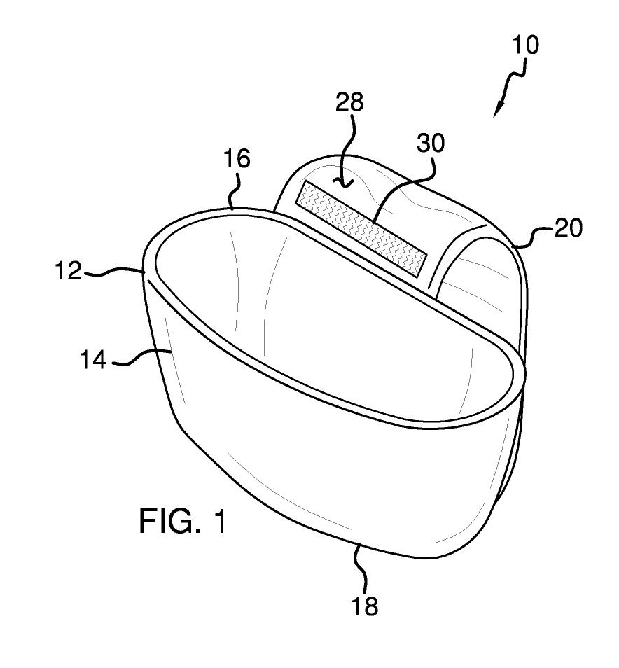

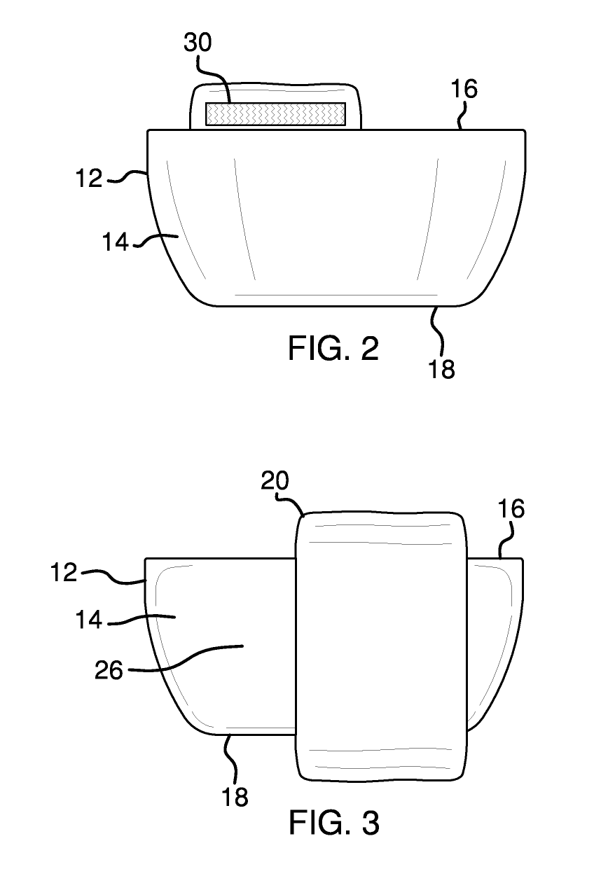

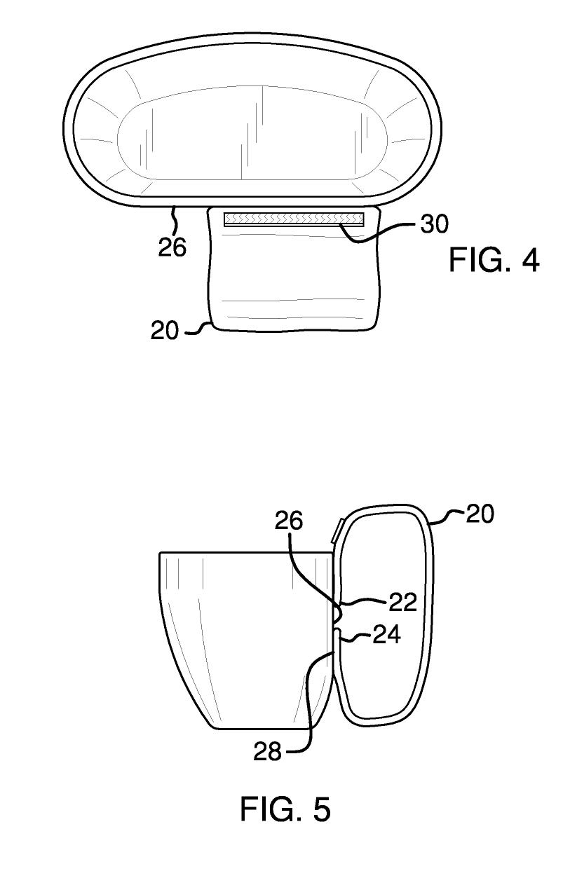

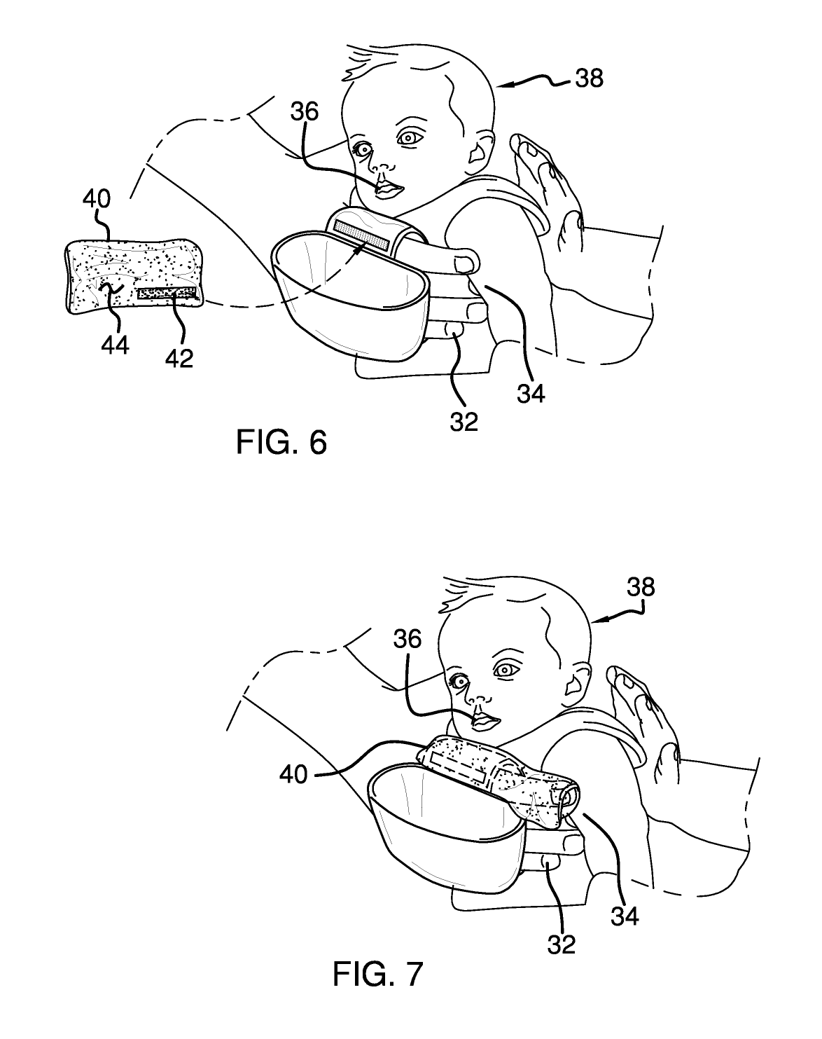

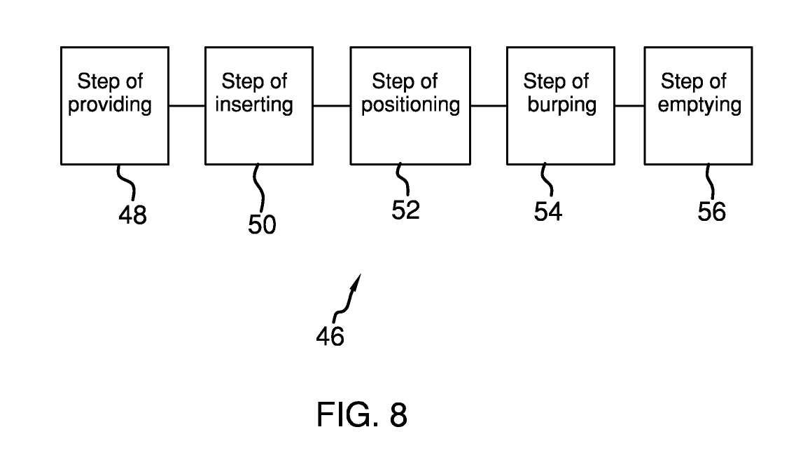

With reference now to the drawings, and in particular to FIGS. 1 through 8 thereof, a new collection device embodying the principles and concepts of an embodiment of the disclosure and generally designated by the reference numeral 10 will be described.

As best illustrated in FIGS. 1 through 8, the vomit collection assembly 10 generally comprises a cup 12. The cup 12 has an external wall 14 extending between a top end 16 and a bottom end 18 of the cup 12. The top end 16 of the cup 12 is open. The bottom end 18 of the cup 12 may have a diameter that is less than a diameter of the top end 16 of the cup 12.

A strap 20 is provided. The strap 20 has a first end 22 and a second end 24. Each of the first 22 and second 24 ends of the strap 20 is coupled to a back side 26 of the external wall 14 of the cup 12. A front surface 28 of the strap 20 abuts the back side 26 of the external wall 14 of the cup 12. Each of the first 22 and second 24 ends of the strap 20 faces each other so the strap 20 forms a closed loop.

A first coupler 30 is coupled to the front surface 28 of the strap 20. The first coupler 30 is positioned proximate the top end 16 of the cup 12. The first coupler 30 extends laterally across the strap 20. The first coupler 30 may comprise a hook and loop coupler of any conventional design.

The strap 20 insertably receives a user's hand 32. The user's hand 32 is positioned on an infant's upper torso 34. The top end 16 of the cup 12 is positionable below the infant's mouth 36. The cup 12 collects the vomit from the infant 38.

A rag 40 is provided. A second coupler 42 is coupled to a rear surface 44 of the rag 40. The second coupler 42 is complementary to first coupler 30. The rag 40 covers the strap 20 and the user's hand 32 so the strap 20 and the user's hand 32 do not contact the vomit. The rag 40 is removed and washed after the infant 38 finishes vomiting.

In use, a method 46 of collecting vomit from the infant 38 includes a step 48 of providing the cup 12 that has the open top end 16 and the strap 20. The method 46 includes a step 50 of inserting the user's hand 32 through the strap 20. Additionally, the method 46 includes a step 52 of positioning the cup 12 beneath the infant's mouth 36. The method 46 further includes a step 54 of burping the infant 38 so the infant 38 vomits into the cup 12. Finally, the method 46 includes a step 56 of emptying the vomit from the cup 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vomit collection assembly configured to collect vomit from an infant after the infant is burped, said assembly comprising:
a cup configured to collect the vomit from the infant; and
a strap coupled to said cup, said strap being configured to insertably receive a user's hand such that said cup is retained proximate the infant's mouth.

2. The assembly according to claim 1, further comprising said cup having an external wall extending between a top end and a bottom end of said cup.

3. The assembly according to claim 1, further comprising a top end of said cup being open.

4. The assembly according to claim 1, further comprising said strap having a first end and a second end.

5. The assembly according to claim 1, further comprising each of a first end and a second end of said strap being coupled to a back side of an external wall of said cup.

6. The assembly according to claim 5, further comprising such that a front surface of said strap abuts the back side of the external wall of said cup having each of said first and second ends of said strap facing each other.

7. The assembly according to claim 5, further comprising said strap forming a closed loop.

8. The assembly according to claim 1, further comprising a top end of said cup being positionable below the infant's mouth such that said cup collects the vomit from the infant.

9. A vomit collection assembly configured to collect vomit from an infant after the infant is burped, said assembly comprising:
a cup having an external wall extending between a top end and a bottom end of said cup, said top end of said cup being open;
a strap having a first end and a second end;
each of said first and second ends of said strap being coupled to a back side of said external wall of said cup such that a front surface of said strap abuts the back side of the external wall of said cup having each of said first and second ends of said strap facing each other, said strap forming a closed loop; and
said strap insertably receiving a user's hand such that said top end of said cup is positionable below the infant's mouth such that said cup collects the vomit from the infant.

10. A method of collecting vomit from an infant, the steps of the method comprising:
a step of providing said cup having said open top end and said strap;
a step of inserting the user's hand through said strap;
a step of positioning said cup beneath the infant's mouth;
a step of burping the infant such that the infant vomits into said cup; and
a step of emptying the vomit from said cup.
